(19) United States
(12) Patent Application Publication
(10) Pub. No.: US 2003/0178737 A1
(43) Pub. Date: Sep. 25, 2003

(54) Method and apparatus for shape forming of degradable polymers under the protection of an inactive gas

(75) Inventors: How Tseng, Taipei (TW); Sheng-Yang Lee, Taipei (TW); Yu-Chi Huang, Taipei (TW); Chien-Chung Yang, Taipei (TW)

Correspondence Address: BACON & THOMAS, PLLC, 625 SLATERS LANE, FOURTH FLOOR, ALEXANDRIA, VA, 22314

(73) Assignee: BIOTECH ONE INC., Taipei (TW)

(21) Appl. No.: 10/390,789

(22) Filed: Mar. 19, 2003

(30) Foreign Application Priority Data
Mar. 25, 2002 (TW) 91105690

(51) Int. Cl. B29C 45/00

(52) U.S. Cl. 264/85; 264/572; 264/328.1; 425/546

(57) ABSTRACT

A method and apparatus for shape forming of degradable polymers under the protection of an inactive gas is disclosed to use an injection-molding machine to mold a degradable polymer into final products, and to use an inactive gas to form an air shield that isolates the supplied degradable polymer from air during injection molding.

### BACKGROUND OF THE INVENTION

1. Field of the Invention

The present invention relates generally to shape forming of degradable polymers and, more specifically, to a method and apparatus for shape forming of degradable polymers under the protection of an inactive gas.

2. Description of the Related Art

Conventionally, injection molding is employed to make thermoplastic polymer products (Mainil-Varlet, 1997, molding injection). During injection molding, polymer is fused into a fluid status in the material passage inside the injection-molding machine, and then a pressure is applied to inject molten polymer into the mold. The heating temperature must surpass the melting point (Tm) of the supplied polymer, so that the supplied polymer can be fused into a fluid status. At this time, the melt flow index (MI), i.e. the important index in the processing of injection molding, is about 10, the optimum parameter. If the MI value of the molten polymer is excessively high (excessively high fluidity number), the shape forming process becomes difficult. If the MI value is excessively low, the shape forming process becomes impossible.

Injection molding is a rapid and efficient method of making polymers into desired shapes. However, this method still has drawbacks as bellows:

(1) The physical and chemical properties of degradable polymer become unstable when in the molten status, resulting in instability of final products.

(2) According to conventional injection molding procedures, polymer is fused under the presence of air. However, the active elements contained in air may cause polymers to change their properties.

Due to the aforesaid drawbacks, the method of injection molding is not suitable for certain materials that are sensitive to heat or environment. For molding materials sensitive to heat or environment, other conventional time-consuming methods shall be used. Therefore, conventional injection molding methods without special protection means cannot be used to mold degradable polymers.

An ideal injection molding protection device shall have the following advantages:

(1) It gives a stable external environment to the molten polymer, keeping the same stable.

(2) It completely isolates the molten polymer from air, preventing contact of the molten polymer with moisture or active elements in air.

(3) It is inexpensive, and its operation is easy.

There are injection molding protection systems and devices developed.

However, these known injection molding protection systems and devices are still not satisfactory in function due to the following drawbacks:

(1) Bulky system size:

Conventional injection molding protection systems and devices are commonly heavy and bulky, occupying much installation space.

(2) Complicated operation procedure:

The operation procedures of conventional injection molding protection systems and devices are commonly complicated and have limitations, causing a barrier to their application.

(3) Poor protection effect:

When injection-molded into final products, the material properties may be changed, for example, the strength may be weakened, the molecular weight may be lowered, water traces may be occurred in the final products due to the pyrolysis effect of the polymer under the poor protection of the conventional injection molding protection systems and devices.

Therefore, it is desirable to have a method and apparatus for shape forming of degradable polymers that eliminates the aforesaid drawbacks.

### SUMMARY OF THE INVENTION

It is the primary objective of the present invention to provide a method and apparatus for shape forming of degradable polymers under the protection of an inactive gas, which effectively maintains the quality of degradable polymers.

It is another objective of the present invention to provide a method and apparatus for shape forming of degradable polymers under the protection of an inactive gas, which is easy to operate without affecting the manufacturing process.

It is still another objective of the present invention to provide an apparatus for shape forming of degradable polymers under the protection of an inactive gas, which is compact, inexpensive, and space saving.

To achieve these objectives of the present invention, the method and apparatus for shape forming of degradable polymers under the protection of an inactive gas is to use an injection-molding machine to mold a degradable polymer into final products, and to supply an inactive gas into the injection-molding machine to form an air shield that isolates the supplied degradable polymer from air during injection molding.

### BRIEF DESCRIPTION OF THE DRAWINGS

FIG. 1 is a schematic drawing showing the arrangement of the first preferred embodiment of the apparatus of the present invention.

FIG. 2 is a schematic drawing showing the arrangement of the second preferred embodiment of the apparatus of the present invention.

FIG. 3 is a bending strength-displacement chart obtained from test strips without inert gas protection.

FIG. 4 is a bending strength-displacement chart obtained from test strips with inert gas protection.

### DETAILED DESCRIPTION OF THE INVENTION

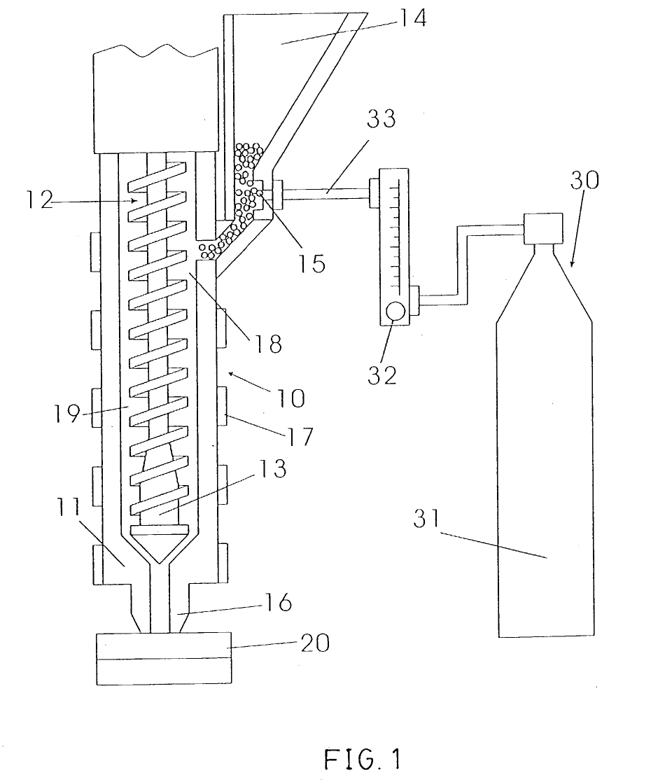

With reference to FIG. 1, an apparatus for shape forming of degradable polymers under the protection of an inactive gas in accordance with the first preferred embodiment of the present invention is shown comprising a vertical injection-molding machine 10, a mold 20, and an inactive gas source 30.

The injection-molding machine 10 comprises a cylinder 11 defining a material passage 12, a feed screw 13 rotatably mounted in the cylinder 11, a hopper 14, a feed pipe 15 connected between the hopper 14 and the cylinder 11, an injection nozzle 16 in the front end of the cylinder 11, and a plurality of electric heating elements 17 arranged around the periphery of the cylinder 11.

The mold 20 is connected to the injection nozzle 16, and adapted to mold molten material injected out of the injection nozzle 16 into shape.

The inactive gas source 30 comprises an air container 31 keeping an inactive gas (for example, nitrogen N₂, argon Ar, or any of a variety of inert gases), a supply pipe 33 connected between the air container 31 and the feed pipe 15 and adapted to deliver the storage inactive gas from the air container 31 to the feed pipe 15, and a control valve 32 installed in the supply pipe 33 and adapted to regulate the flow rate of the storage inactive gas passing through the supply pipe 33. Because the specific gravity of the supplied inactive gas is greater than air, the supplied inactive gas flows downwards into the material passage 12 to force air out of the material passage 12 during the operation of the injection-molding machine 10, forming a layer of air shield at a material feeding zone 18 and a material fusion zone 19 of the material passage 12. Therefore, the supplied degradable polymer is isolated from air when fusing.

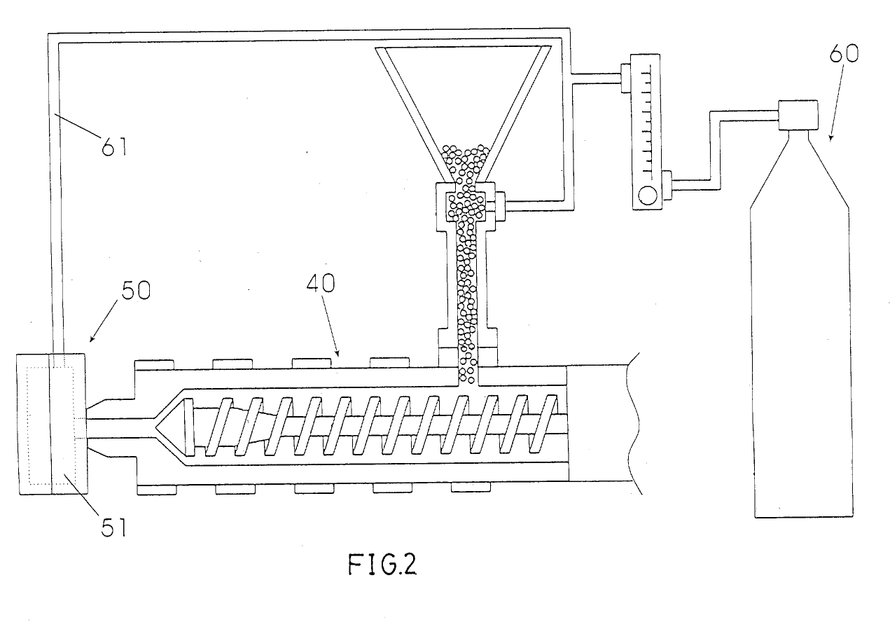

FIG. 2 shows an alternate form of the present invention. This embodiment comprises a horizontal injection-molding machine 40, a mold 50, and an inactive gas source 60. The structure and principle of this alternate form are substantially same as the aforesaid first embodiment with the exception of the arrangement of the supply pipe 61 between the inactive gas source 60 and the mold 50. During the operation of the horizontal injection-molding machine 40, the supplied inactive gas also isolates the fused degradable polymer from air in the shape-forming zone 51 defined in the mold 50.

The effect of the present invention becomes apparatus in the example of the shape forming of a water and temperature sensitive thermoplastic polymer (polylactide). Polylactide is a well-known plastic material (Schneider, 1955). It is a synthesized white color biodegradable semi-crystallite polymer pertaining to the group of poly-alpha hydroxy acids, having a glass transition temperature 57° C. and a melting point 150° C. (Vert et at, 1981). Test strips are made under different conditions, and examined through a bending test and a molecular weight analysis. Poly-L-lactide (PLLA)/Poly-DL-lactide (PDLLA) (95/5) of molecular weight 140kDa and melting point 150° C. are used and injection-molded into test strips of size 6×2×25 mm³ under heating temperature 155° C. and the presence of nitrogen at gas flow rate 20 ml/min.

Mechanical Test:

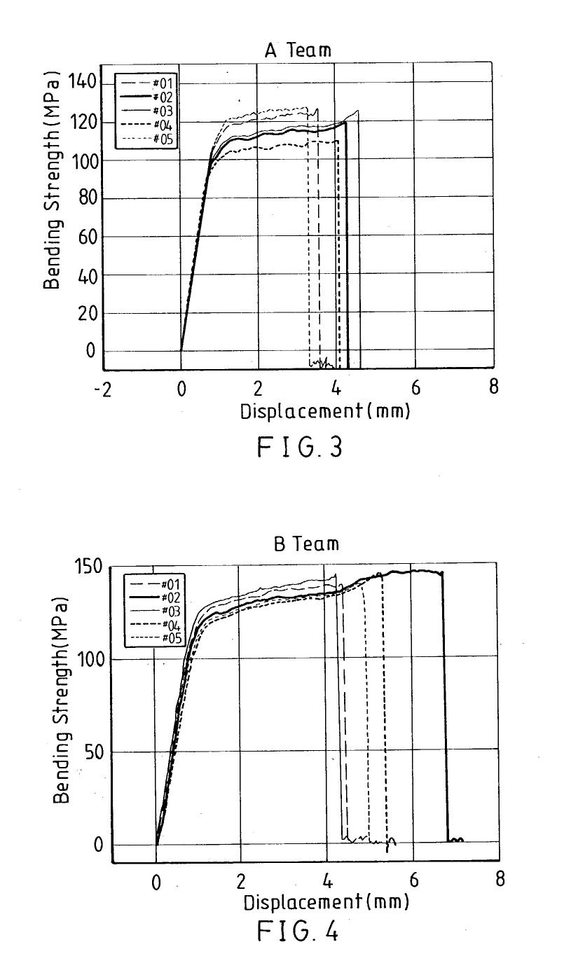

Use a mechanical test system to examine the bending strength of the test samples, observing the variation. The test samples include two groups, i.e., group A and group B. Group A includes 5 test strips injection-molded from prepared degradable polymer without inactive gas protection. Group B includes 5 test strips injection-molded from prepared degradable polymer with inactive gas protection. The test results are obtained and shown in FIGS. 3 and 4 and the following Table I and table II.

TABLE I

| Group A | Bending strength (Mpa) | Group B Bending strength (Mpa) |
|---|---|---|
| #01 | 119.3440638 | 140.3413818 |
| #02 | 111.1952104 | 145.8601789 |
| #03 | 125.682066 | 145.4721379 |
| #04 | 126.7168375 | 147.7572661 |
| #05 | 127.8378379 | 140.0826759 |

TABLE II

| | Bending | | |
|---|---|---|---|
| Group A | strength (Mpa) | Group B | Bending strength (Mpa) |
| Average | 122.1552031 | Average | 143.9027281 |
| Standard | 3.110976964 | Standard | 1.556086604 |
| error | | error | |
| Standard | 6.956355966 | Standard | 3.479515425 |
| deviation | | deviation | |

Molecular Weight Variation:

Subject to material detention time in the feed pipe, tests samples are divided into 8 groups each containing two pieces as follows:

1. Without inert gas protection, detection time 0 minute

2. Without inert gas protection, detention time 10 minutes

3. Without inert gas protection, detention time 15 minutes

4. Without inert gas protection, detention time 30 minutes

5. With inert gas protection, detention time 0 minute

6. With inert gas protection, detention time 10 minutes

7. With inert gas protection, detention time 15 minutes

8. With inert gas protection, detention time 30 minutes

| | | Without | | With | |
|---|---|---|---|---|---|
| Original | | inert gas protection | | inert gas protection | |
| material | Molecular weight | 140,000Da | | 140,000Da | |
| Detention | Molecular weight | 125,374Da | 121,735Da | 132,166Da | 138,573Da |
| time 0 min | Molecular weight distribution | 1.71892 | 1.85731 | 1.60374 | 1.51487 |
| Detention | Molecular weight | 73,045Da | 71,317Da | 118,372Da | 109,844Da |
| time 10 min | Molecular weight distribution | 2.08982 | 1.98772 | 1.91432 | 1.8785 1 |
| Detention | Molecular weight | 32,675Da | 31,115Da | 97,245Da | 92,337Da |
| time 15 min | Molecular weight distribution | 1.98517 | 2.05248 | 2.08154 | 2.11372 |
| Detention | Molecular weight | 21,305Da | 21,320Da | 65,371Da | 73,928Da |
| time 30 min | Molecular weight distribution | 1.60337 | 1.56449 | 1.95837 | 1.73262 |

From the indication of the aforesaid test result, the protection of an inactive gas effectively lowers the pyrolysis effect of polymers.

What is claimed is:

1. A method for shape forming of degradable polymers comprising the step of applying an inactive gas, which will not react with the polymer, to form an air shield to isolate a supplied degradable polymer from air when molding the supplied degradable polymer.

2. The method as claimed in claim 1, wherein said inactive gas is supplied to form the air shield between a material feeding zone where the degradable polymer to be molded is supplied and a material fusion zone where the supplied degradable polymer is melted.

3. The method as claimed in claim 2, wherein said inactive gas is supplied to a shape-forming zone where the supplied degradable polymer is molded.

4. The method as claimed in claim 1, wherein said inactive gas is selected from inert gases including nitrogen and argon.

5. A method for shape forming of degradable polymers comprising the step of using an injection-molding machine to mold a supplied degradable polymer, and the step of supplying an inactive gas to said injection-molding machine to form an air shield between a material feed zone and a material fusion zone inside said injection-molding machine to isolate the supplied degradable polymer from air during the operation of said injection-molding machine.

6. The method as claimed in claim 5 further comprising the step of supplying said inactive gas to a shape-forming zone where the supplied degradable polymer is molded.

7. An apparatus for shape forming of degradable polymers comprising:
an injection-molding machine having a cylinder defining a material passage therein, a feed screw rotatably mounted in said cylinder, a hopper communicated with said cylinder, and an injection nozzle in a front end of said cylinder; and
an inactive gas source connected to said hopper and adapted to supply an inactive gas to fill up said material passage.

8. The apparatus as claimed in claim 7, wherein said inactive gas source comprises a container keeping the inactive gas, and a control valve adapted to control the flow rate of the storage inactive gas to said material passage.

9. The apparatus as claimed in claim 7, further comprising a mold connected to said injection nozzle, and a supply pipe adapted to guide the inactive gas from said inactive gas source to said mold.
